(19) United States
(12) Patent Application Publication
(10) Pub. No.: US 2002/0080143 A1
(43) Pub. Date: Jun. 27, 2002

(54) Rendering non-interactive three-dimensional content

(76) Inventors: David L. Morgan, Redwood City, CA (US); Ignacio Sanz-Pastor, San Francisco, CA (US)

Correspondence Address: FENWICK & WEST LLP, TWO PALO ALTO SQUARE, PALO ALTO, CA, 94306, US

(21) Appl. No.: 10/004,901

(22) Filed: Nov. 7, 2001

Related U.S. Application Data
(60) Provisional application No. 60/247,528, filed on Nov. 8, 2000.

(51) Int. Cl. G09G 5/00

(52) U.S. Cl. 345/581

(57) ABSTRACT

Using a variety of three-dimensional computer graphics techniques, which exploit non-interactivity and three-dimensional rendering hardware for interactive images at the viewer, non-interactive three-dimensional content is rendered at high quality and/or low bandwidth. This is achieved using an offline optimization process to perform specific pre-computations of three-dimensional graphics parameters, which are encoded into a bandwidth-efficient representation for delivery to a computer system having a real-time three-dimensional renderer for display to viewers.

### CROSS-RELATED APPLICATION

This application claims priority under 35 U.S.C. §119(e) to U.S. Provisional Patent Application Serial No. 60/247,528, “RENDERING NON-INTERACTIVE 3D CONTENT,” by David L. Morgan III and Ignacio Sanz-Pastor, filed Nov. 8, 2000. The subject matter of the foregoing is incorporated herein by reference in its entirety.

### BACKGROUND OF THE INVENTION

### INCORPORATION BY REFERENCE

This application includes the following references, which are included herewith and are incorporated by reference in their entirety: Arvo, “Backwards ray tracing” Siggraph 86 development in ray tracing course notes; Bui Ton Phong 1975, Illumination for Computer generated pictures, Comm. of ACM 18, June 1975; Catmull, A Hidden Surface Algorithm with Anti-Aliasing, SIGGRAPH 78 Proceedings, 1978; Crow, Franklin, The use of Grayscale for Improved Raster Display of Vectors and Characters, SIGGRAPH 78 Proceedings, 1978; Foran, Leather: “Antialiased imaging with improved pixel supersampling,” U.S. Pat. No. 6,072,500; Heckbert, “Survey of texture mapping,” IEEE Computer Graphics and Applications, November 1986; Lengel, Snyder: SIGGRAPH '97 proceedings p. 233; Migdal, et al.: “ClipMap: a virtual mipmap” Siggraph 98; Reeves siggraph 83, “Particle systems: a technique for modelling a class of fuzzy objects”; Rohlf, Helman “IRIS Performer: a high performance multiprocessing toolkit for real time graphics” Siggraph 94; Snyder, Lengel: SIGGRAPH '98 proceedings p. 219; Sutherland, et al, A Characterization of Ten Hidden-Surface Alogorithms, Computing Surveys, Vol. 6, No. 1, March 1974; Torborg, Kajiya: SIGGRAPH '96 proceedings p. 353; Williams, “Pyramidal Parametrics” Siggraph 1983; and Zhang, Hansong, Effective Culling for the Interactive Display of Arbitrary Models, Dissertation at UNC, 1998. This application further incorporates by reference all documents referred to in the text but not listed above.

### FIELD OF THE INVENTION

The present invention relates to the field of computer graphics.

### RELATED ART

As a result of increased realism of Computer-Generated Images (CGI) and compelling storytelling by computer graphics artists, there is an increasing demand for three-dimensional (3D) non-interactive content. For example, 3D computer graphics are commonly used in the creation of non-interactive content such as movies and television. Most modem feature films, including Star Wars: The Phantom Menace, Fight Club, What Dreams May Come, The Nutty Professor, etc., include a mixture of live-action and 3D CGI elements. Some feature films, such as Toy Story II, A Bug's Life, Antz, Final Fantasy, etc. are entirely 3D CGI. Additionally, many television advertisements, such as the Rhythm&Hues' Coca Cola polar bears and Blue Sky Studios' Braun Razor are also entirely 3D CGI. There are also animated television series, such as South Park, Starship Troopers, and Reboot, which are entirely 3D CGI.

Three dimensional computer graphics have been used widely in interactive and non-interactive content since the early 1990s. The difference between 3D and non-3D content is that 3D content is at some point represented as a geometrical representation of characters, lighting and a camera in 3-dimensional space. Non-3D content, such as film shot of the real world, does not contain such geometrical representations of what is seen. Even if that film is of a perfectly spherical ball, no explicit geometrical representation of the ball was used, so the content is not 3D. Content may be a composition of 2D (images) and 3D elements. An example of this is the water tentacle scene in the film The Abyss. In this scene, a 3D model of a spooky water tentacle is composited into a sequence of shots filmed with a movie camera such that the live actors (which are not 3D content) appear to interact with the synthetic 3D water tentacle.

There are a number of common reasons why 3D CGI is used to create content. CGI is used in live-action films or television programs for producing special effects that are either prohibitively expensive or impossible in the real world. CGI is used in films such as Antz to tell the stories of characters (miniscule ants in this example) in a more compelling and realistic way than would be possible with actors, costumes and sets or traditional cell animation.

One reason that 3D CGI is so desirable is that the content creation process produces “assets” in addition to the final content program. Such assets include 3D models of characters, sets and props, which may be inexpensively reused for other content. Examples of this asset reuse include the migration of the Pod Racer models in Star Wars: The Phantom Menace film to the LucasArts' Pod Racer video games, and the migration of the characters created for Toy Story to Toy Story II.

All of the foregoing examples of 3D CGI content are examples of non-interactive 3D content: content that is meant to be viewed primarily passively, as opposed to most video games, with which players constantly interact. Non-interactive content differs substantially from interactive content, both technically and in terms of the content consumer. The consumers of interactive content are “players,” as in a game. Players constantly and actively control some aspect of interactive content, such as the actions of a fighting character or the first-person motion of a “camera” in real time. In contrast, the consumers of non-interactive content are “viewers,” as in a movie theater. Viewers, for the most part, passively watch non-interactive content. Non-interactive content tends to be “linear,” meaning there is a predetermined sequence of events that unfolds before the viewer. Non-interactive content can also be “piecewise linear.” Examples of piecewise linear content include pausing or fast-forwarding a VCR, skipping a commercial on a Tivo personal video recorder or the viewer of a digital versatile disc (DVD) player making choices that affect the outcome of a story (for example, which ending of a movie is played). Piecewise linear content is not considered interactive because it lacks the real time interaction characteristic of interactive content.

In many types of interactive content, the player interacts with the content at roughly the same rate the individual images comprising the content are displayed. For television in the United States, this rate is 30 frames per second. This means that, in addition to drawing the images every 1/30 (33.3 ms) of a second, the content (i.e., game) also samples the player's input at an interval that is a small multiple of 33.3 ms (e.g., less than 100 ms). For interactive content, frequent sampling is important because infrequent sampling of user input causes unpleasant jerkiness of motion in the scene.

Modem video games frequently include a mixture of interactive and non-interactive content, where non-interactive content, in the form of introductory or transition movies, “set the stage” for the rest of the game. These short non-interactive segments typically are either stored as video or are rendered with the same rendering engine used for the interactive content (i.e., gameplay). When the rendering engine used in the game is re-used for these non-interactive sequences, their quality and detail matches the interactive parts of the game.

The means by which non-interactive and interactive content are delivered also differ greatly. Non-interactive audiovisual content has historically been delivered by film in movie theaters, by television signals through the air or cable, or on video tapes or DVDs. Interactive content is usually delivered via some “game engine,” which is a real time interactive two-dimensional (2D) or 3D graphics application typically distributed through arcades or as a software product. The technologies for delivery of interactive and non-interactive content are very different, with very different challenges for each technology.

While interactive technologies are concerned with image quality, real time performance is usually the primary concern. There is a constant tradeoff in real time technologies between image quality and real time performance. For home video game consoles, the performance requirement has been constant—30 frames per second (actually 60 fields per second). Each successive generation of hardware has improved rendering performance over prior generations (more powerful graphics processors). This improved rendering performance manifests itself as improved image quality, in the form of more detailed and realistic scenes. However, because of the requirement of real time interactivity, video games still have not been able to match the quality of non-interactive content such as movies.

In contrast, the goal for non-interactive technologies typically is maximizing image quality. Examples of such technologies are improved lenses to minimize flaring, and high-quality videotape media innovations. More recent non-interactive technologies such as MPEG video also have the goal of “fitting” a program within a specific bandwidth constraint.

Three dimensional non-interactive content is usually created by first creating models of elements (e.g., sets, characters, and props) for a particular shot. There are many commercial modeling packages such as Alias Studio and 3D Studio Max that can be used for creating models. These models typically include a geometrical representation of surfaces, which may be polygons, Bezier patches, NURBS patches, subdivision surfaces, or any number of other mathematical descriptions of 3D surfaces. The models typically also include a description of how the surfaces interact with light. This interaction is called shading. Shading is typically described using texture maps or procedural shaders, such as shaders for Pixar's RenderMan system. If the content is non-interactive, the models are then placed in a scene with lights and a camera, all of which may be animated as part of some story. In terms of 3D graphics, animation refers to describing the motion or deformation of scene elements (including objects, lights and camera) over the course of a shot. The same commercial tools mentioned above provide a variety of simple and sophisticated means for animating shots. These tools typically manipulate the scene elements using wireframe methods, which allow the object geometry to be manipulated and redrawn rapidly during adjustment. In contrast, for interactive 3D content, animation is specified in a much more limited manner. Animators may describe how a character kicks, punches, falls down, etc., but the character's placement within the scene, and the choice of which animation sequences to use are ultimately made by the player in real time.

Once a shot has been adequately described, the shot is rendered. Rendering is the process of converting the geometry, shading, lighting and camera parameters of the shot from their 3D descriptions into a series of 2D images, or “frames.” This is performed through a process of mathematically projecting the geometry onto the focal plane represented by the screen, and evaluating shading calculations for each pixel in each frame. These frames will ultimately be displayed in succession, as in a flip-book, on a movie screen or CRT for viewers. In the case of non-interactive content, this rendering usually occurs “offline” due to its computational complexity. Offline renderers, such as RenderMan, take up as much processor time as is necessary to convert the 3D scene description to 2D images. For complex scenes, this can take days or weeks to render each frame. Conversely, simpler scenes render more quickly. Because the rendering process is fully decoupled from the display system (movie projector or video tape player), the amount of rendering time required is irrelevant to the viewer. Interactive renderers, however, must render in real time. If a scene is too complex, the rendering takes longer than the time allowed by the real time constraint and the result is jerkiness, non-real time interaction and other unpleasant artifacts. Real time renderers, therefore, place strict limits on scene complexity, thus limiting image quality. Because of these two very different rendering mechanisms, non-interactive 3D content generally has higher image quality than interactive content.

In the traditional model, after non-interactive 3D content is rendered, it is distributed. For example, the individual frames may be printed to film for projection in theatres, or stored on a video tape for later broadcast, rental or sale, or digitally encoded into a compressed format (such as Quicktime, MPEG, DVD or RealVideo). Means for distribution of digital video include CDs, DVDs, Internet distribution (using either streaming or downloading mechanisms), digital satellite services, and through broadcasts in the form of digital television (DTV).

Non-interactive 3D content encoded using these traditional digital formats requires as much bandwidth as non-3D content, such as live video. This is because any 3D information that could enhance the compression of the content is discarded during the rendering process. NTSC-quality streaming video is inaccessible over digital networks with insufficient bandwidth, such as DSL and wireless networks.

Additionally, using conventional compression systems, HDTV-resolution streams require more bandwidth than NTSC, proportional with the increase in resolution. It is impossible to offer on-demand HDTV-resolution content using currently available delivery infrastructure. Because there is demand for creative, high-quality non-interactive 3D content, there is a need to deliver it at reduced bandwidth. It is also desirable to have this content available in an on-demand format, as in the Internet.

### SUMMARY OF INVENTION

The present invention provides various embodiments for overcoming the limitations of the prior art by performing optimizations to achieve higher image quality of non-interactive three-dimensional images rendered by a 3D renderer. These embodiments produce 3D rendering information by optimizing 3D descriptions of non-interactive image data. Three-dimensional rendering information includes information, such as commands and data, necessary for rendering an image. An example of 3D rendering information is 3D scene descriptions. One example of the 3D description is 3D scene description data which is lost during rendering in the traditional 3D production pipeline. The 3D rendering information is optimized for rendering by a specific type of computer system having a 3D real-time renderer or rendering engine. The optimizations performed also account for the characteristics of the physical infrastructure by which the 3D rendering information is accessed by the specific type of computer system. Examples of physical infrastructure include the Internet and permanent storage media such as DVDs. For example, optimizations may be performed to meet the bandwidth requirements of a particular infrastructure.

Thus, instead of receiving information representing each already rendered 2D frame, the specific type of computer system receives information, including data and commands, representing 3D modeling of the frame. The computer system then renders the 3D rendering information. In other words, rather than rendering each frame offline and then playing back the already rendered frames, as would be the case in the traditional approach, each frame is rendered by the three-dimensional renderer of the computer system, preferably in real time, for display at the display's update rate (e.g., 60 Hz for NTSC television). This is particularly efficient since so-called “third generation” game console systems, such as the Sony Playstation, Sega Saturn and Nintendo N64, introduced 3D rendering technology to the home game system market. Modem game console systems such as the Sony Playstation 2 and Nintendo GameCube are capable of rendering millions of texture-mapped polygons per second.

As a result, a viewer is able to view on a display coupled to the specific type of computer system non-interactive three-dimensional images, such as in a movie, that is rendered by the 3D renderer of the specific computer system yet has image quality comparable to that of non-interactive 3D images that have already been rendered offline and saved to a two-dimensional 2D format such as film or video.

Examples of systems having a 3D renderer or 3D rendering engine include the Sony Playstation II, Sega Dreamcast, Nintendo GameCube, Silicon Graphics workstations, and a variety of PC systems with 3D accelerators such as the nVidia GeForce. In these examples, the rendering engines developed for these computer systems are dedicated to the display of interactive 3D content. Accordingly, the 3D content, which may be embodied in game cartridges, CD-ROMs and Internet game environments have also been optimized for interactivity.

In optimizing the 3D descriptions, the 3D rendering information is computed and encoded to take advantage of or account for the noninteractive nature of the content. The non-interactive nature of the content includes the “linear” and/or “piecewise linear” aspects of non-interactive content. In other words, the sequence of modeled objects appearing, for example, in a scene, is known. In contrast, 3D rendering of of interactive content involves real-time rendering in which the sequence of modeled objects appearing on the display is mostly undetermined due to user control of an aspect of the image content.

Additionally, the optimizations take advantage of or account for the graphics capability of the computer system. Graphics capability comprises hardware or software or combinations of both for rendering 3D rendering information into images. An embodiment of graphics capability is a graphics sub-system including a dedicated data processor for rasterizing polygons into a frame buffer. The graphics capability may also comprise software which when executed on a computer system provides 3D rendering.

Furthermore, the 3D rendering information is optimized for the characteristics of the physical infrastructure. For example, the rendering information is optimized to be transmitted within the bandwidth of the physical infrastructure for transferring it to the specific type of computer system.

### BRIEF DESCRIPTION OF THE DRAWINGS

FIG. 1 illustrates an embodiment of a system for distributing non-interactive three-dimensional image data to a computer system having a real-time three-dimensional renderer according to the present invention.

FIG. 2 illustrates an embodiment of an overall method for distributing non-interactive three-dimensional image data to a computer system for rendering having a real-time three-dimensional renderer according to the present invention.

FIG. 3 illustrates an embodiment of a system for an Optimizing Encoder according to the present invention.

FIG. 4 illustrates an embodiment of a system for optimizing non-interactive three-dimensional image data for rendering by a computer system having a real-time three-dimensional renderer.

FIG. 5 depicts an example of a computer system equipped with a three-dimensional graphics pipeline suitable for use with the present invention.

FIG. 6 illustrates an embodiment of a method of optimizing for a specific type of computer system using feedback information for the computer system.

FIG. 7 illustrates an embodiment of a method for computing a warp mesh for Image Based Rendering.

FIG. 8 is an example image from a 3D short subject.

FIG. 9 is a block diagram illustrating software modules of one embodiment of a player computer system.

### DETAILED DESCRIPTION

It is understood by those of skill in the art that the various embodiments of the systems and methods of the invention may be embodied in hardware, software, firmware or any combination of these. Additionally, those skilled in the art will appreciate that although the modules are depicted as individual units, the functionality of the modules may be implemented in a single unit or any combination of units.

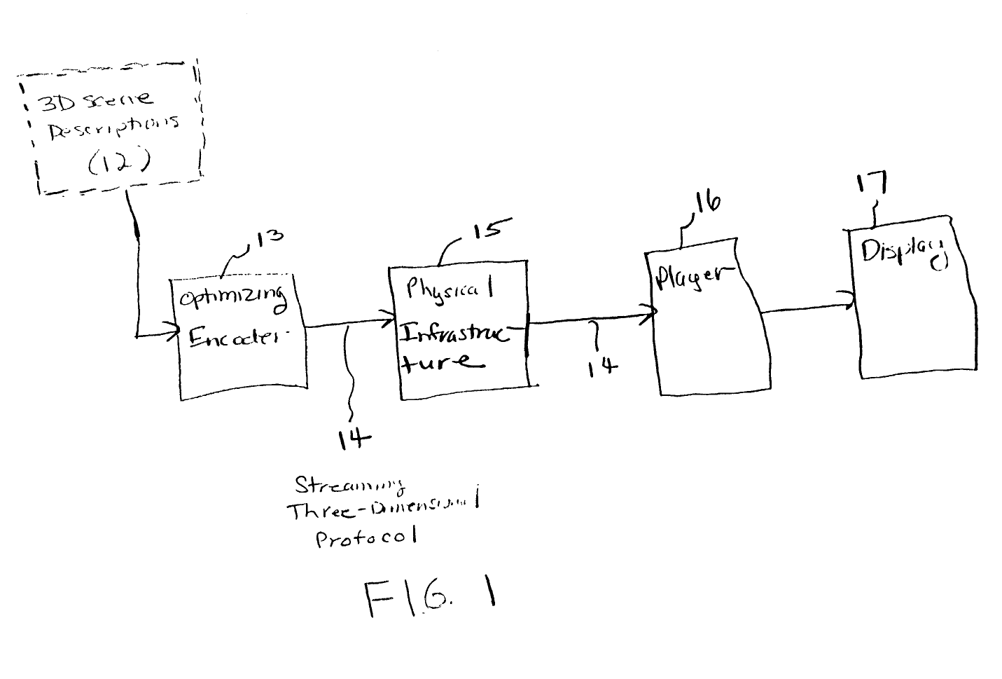

FIG. 1 illustrates an embodiment of a system for distributing non-interactive three-dimensional image data to a computer system having a real-time three-dimensional renderer according to the present invention. As discussed, real-time 3D renderers are commonly found in interactive computer systems in which a user controls an aspect of the image content so that the sequence of objects to be displayed is unable to be determined to a high degree of certainty. A constraint typically placed on real-time renderers is to keep up with the display rate of the display device.

The system in FIG. 1 comprises an optimizing encoder 13 coupled to a physical infrastructure 15, coupled to a player 16, and a display 17 coupled to the player 16. In the discussion of the embodiments which follow, the player 16 is not a person but an embodiment of a computer system having a real-time three-dimensional renderer. Those of skill in the art will understand that a 3D renderer may be embodied in hardware, software or a combination of both. The player 16 is also known as a game console platform.

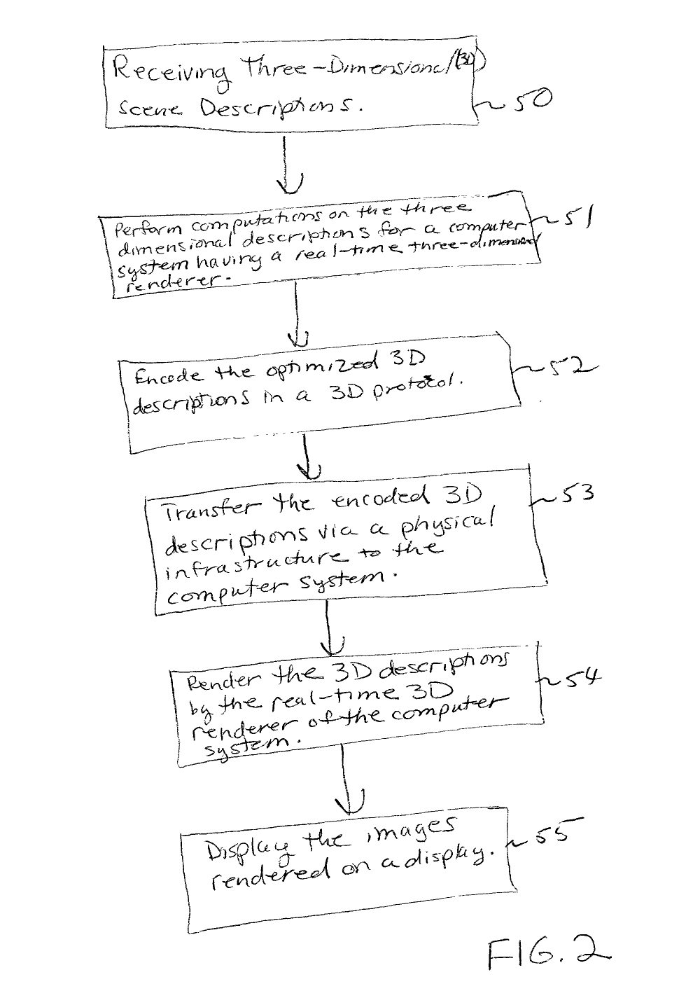

FIG. 2 illustrates an embodiment of an overall method for distributing non-interactive three-dimensional image data to a computer system having a real-time three-dimensional renderer according to the present invention. The method of FIG. 2 is discussed in the context of the system of FIG. 1, but is not limited to operation within the embodiment of the system of FIG. 1.

The optimizing encoder 13 receives 50 three-dimensional descriptions of image content, in this example, three-dimensional scene descriptions 12. Those of skill in the art will understand that image content or content comprises image data that may be for a complete scene, or for a frame of a scene, or for an element of a scene or any combination of scene elements. An example of an element is an object in a scene. Content creators (e.g., animators, technical directors, artists, etc.) produce content as they would in the traditional delivery model, typically using industry-standard or proprietary 3D modeling tools. The resulting 3D scene descriptions 12 of the content are typically produced by exporting the content from these tools.

For example, standard formats for 3D scene descriptions include the RIB format. RIB is a partial acronym for RenderMan Interchange. RIB is in wide use in the film industry as a scene interchange format between interactive authoring tools and photo-realistic rendering systems. The primary application of such photo-realistic rendering systems is film as in the traditional approach where 3D scene descriptions are rendered offline to produce for example, the individual frames of a movie. Proprietary formats may also be implemented through the use of format-specific plug-ins, which allow exportation of scene descriptions from modeling and animation tools.

In the system and method of delivery described herein in accordance with the present invention, however, the 3D scene descriptions 12 are received 50 by the Optimizing Encoder 13. The 3D Descriptions 12 describe the 3D modeling of the content. Common elements which may be included as part of the 3D scene descriptions 12 include object geometry, surface shaders, light shaders, light, camera and object animation data. In one embodiment, the 3D scene descriptions 12 are in a format containing temporal data that correlates scene data from one frame to another. Additionally, information which is not required for traditional rendering may also be sent as part of the 3D scene descriptions to the Optimizing Encoder in order to enhance the optimization procedure. For example, an “importance” parameter assigned to each scene element may be used during optimization to manage tradeoffs of rendering quality.

The encoder 13 optimizes these scene descriptions 12 for a computer system having a real-time three-dimensional renderer which in FIG. 1 is the player 16. For example, the Optimizing Encoder 13 performs the computation and encoding which takes advantage of or accounts for the non-interactive nature of the content. For example, because the sequence of objects displayed is pre-determined, in the situation in which an object no longer appears in a scene, the 3D rendering information for the remaining frames does not include information for redrawing this object. The optimizing encoder 13 may also perform computation and encoding which takes advantage of the graphics capability of the computer system, in this example Player 16. Additionally, the optimizing encoder 13 accounts for characteristics of the physical infrastructure 15 such as bandwidth constraints.

The Opimizing Encoder 13 performs 51 computations on the 3D descriptions for a computer system having a real-time 3D renderer which in this example is player 16.The Optimizing Encoder 13 encodes 52 optimized versions 14 of the 3D scene descriptions using a 3D Protocol, which in the example of FIG. 1 is a streaming 3D Protocol 14. The Protocol is 3D in the sense that the content is still described in terms of 3D models, as opposed for example to bitmaps of consecutive frames of content. A streaming protocol enables Player 16 to begin displaying the content for the viewer before the entire stream has been conveyed across Physical Infrastructure 15. Even if Physical Infrastructure 15 is a DVD or other physical media, a streaming protocol is still preferred because it allows the bulk of the optimization process to be performed in a media-independent manner.

Preferably, different bit streams 14 are produced for different types of Players 16 and different types of physical infrastructure. For example, if Player 16 were a Sony Playstation II, it would have different graphics capability than a personal computer (PC). If infrastructure 15 were the Internet, it would have different characteristics than a DVD. These differences preferably are taken into account by the optimizing encoder 13, leading to different optimizations and/or encodings and therefore different bit streams 14 for different types of computer systems for rendering interactive image content.

The optimizing encoder 13 sends the optimized descriptions in the protocol 14 to the physical infrastructure 15. The physical infrastructure 15 transfers 53 the optimized three-dimensional descriptions 14 encoded in the protocol to the interactive image rendering computer system, the player 16. In the example of FIG. 1, the bit streams 14 are conveyed or transferred over the Physical Infrastructure 15 to the Player 16. The physical infrastructure 15 may be embodied in various types of media and networks. Examples of such infrastructure 15 include digital subscriber lines (DSL); cable modem systems; the Internet; proprietary networks (e.g., the Sony interactive game network); DVD; memory card distribution; data cartridge distribution; compact disc (CD) distribution; television and other types of broadcast.

The real-time 3D renderer of player 16 renders 54 the optimized three-dimensional descriptions. In the embodiment of FIG. 1, the Player 16 has graphics capability such as hardware and/or software for rendering image data into images. An embodiment of graphics capability is a graphics sub-system including a dedicated data processor for rasterizing polygons into a frame buffer. In another embodiment, the player 16 includes proprietary software running on a computer system capable of 3D rendering of interactive content (e.g., Sony Playstation, Nintendo GameCube, Microsoft Xbox). The player 16 is coupled to a display 17. The player 16 renders each frame of the content to a suitable display device 17 (typically, a television screen or other type of monitor) for displaying 55 the images rendered on a display for presentation to a viewer.

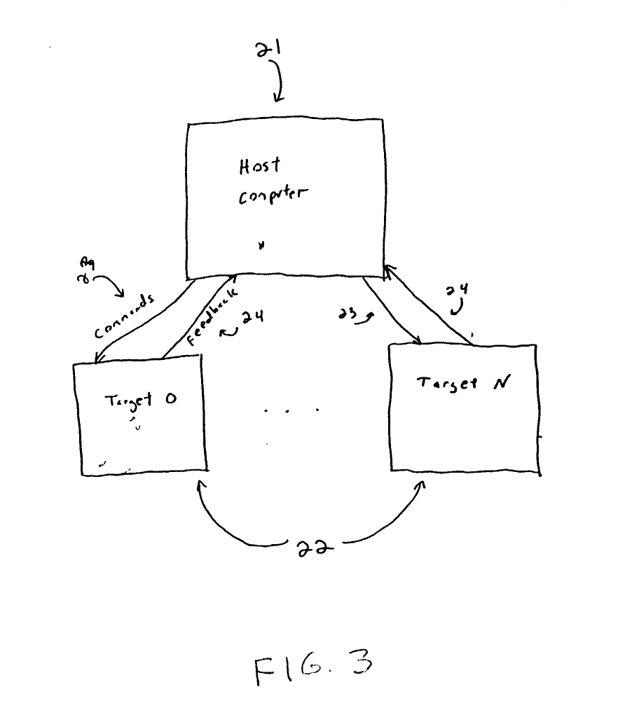

FIG. 3 illustrates an embodiment of a system for an Optimizing Encoder according to the present invention.

It includes a host computer system 21 communicatively coupled to one or more target-specific computer system models 22, each of which represents a computer system containing a graphics subsystem preferably identical to that of a target platform (i.e., the Player 16 for which the bit stream 14 is being optimized). The host computer refers to a computer system for controlling the optimizing of three-dimensional non-interactive image content for a target computer system. A target computer system or target platform refers to a particular type or embodiment of a computer system having a three-dimensional renderer.

The host 21 is connected to the targets system models 22 for the conveyance of scene data and commands 23 to the targets 22 and for receiving feedback data 24 from the targets 22. Feedback data of feedback information typically includes rendered pixels from target frame buffers, rendering time measurements for whole scenes or subsets, and command error reporting. The feedback loop formed by host 21 and each target 22 is used for computing the optimized target-specific bit streams 14. In one embodiment, the host system 21 is one computer and a target system model 22 is the actual hardware being targeted (e.g., an actual Sony Playstation II). In another embodiment, a target system model 22 is a software simulation of the actual target. In this embodiment, the Optimizing Encoder 13 may be implemented as software running on a server equipped with a model of a target such as Player 16. In another embodiment, the target computer system is simulated by a graphics sub-system, such as the graphics pipeline 512, described below, that may be embodied in a peripheral connected via a communications infrastructure such as a bus to the central processing unit of the host computer. In an alternate configuration, the host 21 and the target simulation or dedicated hardware 22 are implemented in a single, shared computer system.

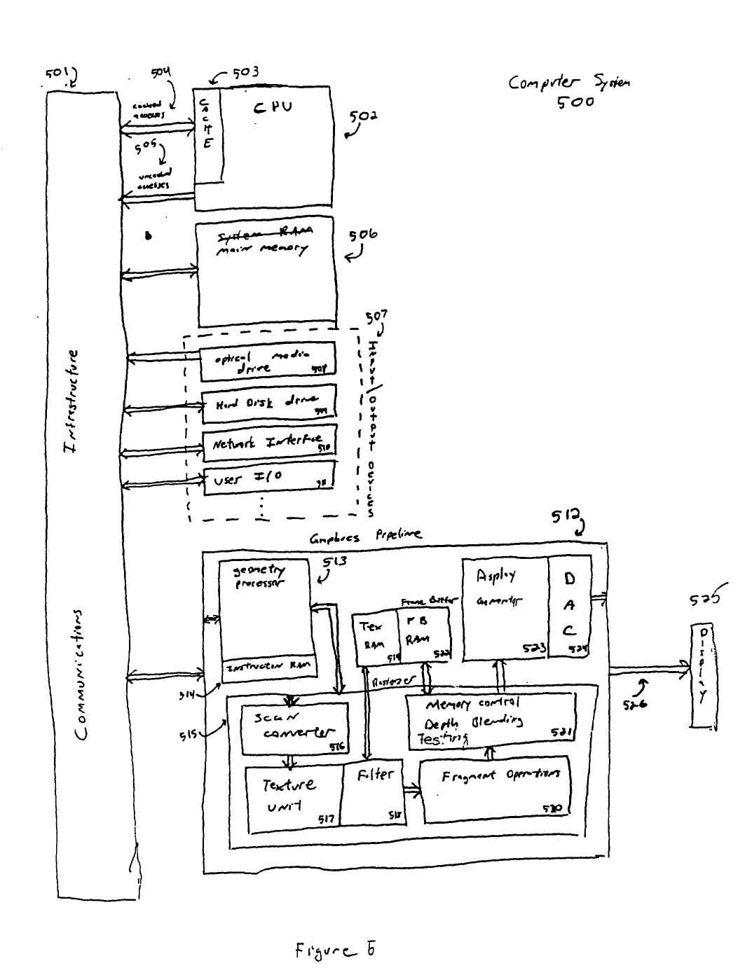

FIG. 5 depicts an example of a computer system 500 equipped with a three-dimensional graphics pipeline suitable for use with the present invention. The graphics pipeline is one embodiment of a three-dimensional renderer or a real-time three-dimensional renderer. Computer system 500 may be used to implement all or part of Player 16 and/or Optimizing Encoder 13. This example computer system is illustrative of the context of the present invention and is not intended to limit the present invention. Computer system 500 is representative of both single and multi-processor computers.

Computer system 500 includes one or more central processing units (CPU), such as CPU 503, and one or more graphics subsystems, such as graphics pipeline 512. One or more CPUs 503 and one or more graphics pipelines 512 can execute software and/or hardware instructions to implement the graphics functionality of Player 16 and/or Optimizing Encoder 13. Graphics pipeline 512 can be implemented, for example, on a single chip, as part of CPU 503, or on one or more separate chips. Each CPU 503 is connected to a communications infrastructure 501 (e.g., a communications bus, crossbar, or network). After reading this description, it will become apparent to a person skilled in the relevant art how to implement the invention using other computer systems and/or computer architectures.

Computer system 500 also includes a main memory 506, preferably random access memory (RAM), and can also include input/output (I/O) devices 507. I/O devices 507 may include, for example, an optical media (such as DVD) drive 508, a hard disk drive 509, a network interface 510, and a user I/O interface 511. As will be appreciated, optical media drive 508 and hard disk drive 509 include computer usable storage media having stored therein computer software and/or data. Software and data may also be transferred over a network to computer system 500 via network interface 510.

Graphics pipeline 512 includes frame buffer 522, which stores images to be displayed on display 525. Graphics pipeline 512 also includes a geometry processor 513 with its associated instruction memory 514. In one embodiment, instruction memory 514 is RAM. The graphics pipeline 512 also includes rasterizer 515, which is in electrical communication with geometry processor 513, frame buffer 522, texture memory 519 and display generator 523. Rasterizer 515 includes a scan converter 516, a texture unit 517, which includes texture filter 518, fragment operations unit 520, and a memory control unit (which also performs depth testing and blending) 521. Graphics pipeline 512 also includes display generator 523 and digital to analog converter (DAC) 524, which produces analog video output 526 for display 525. Digital displays, such as flat panel screens would use digital output, bypassing DAC 524. This example graphics pipeline is illustrative of the context of the present invention and not intended to limit the present invention.

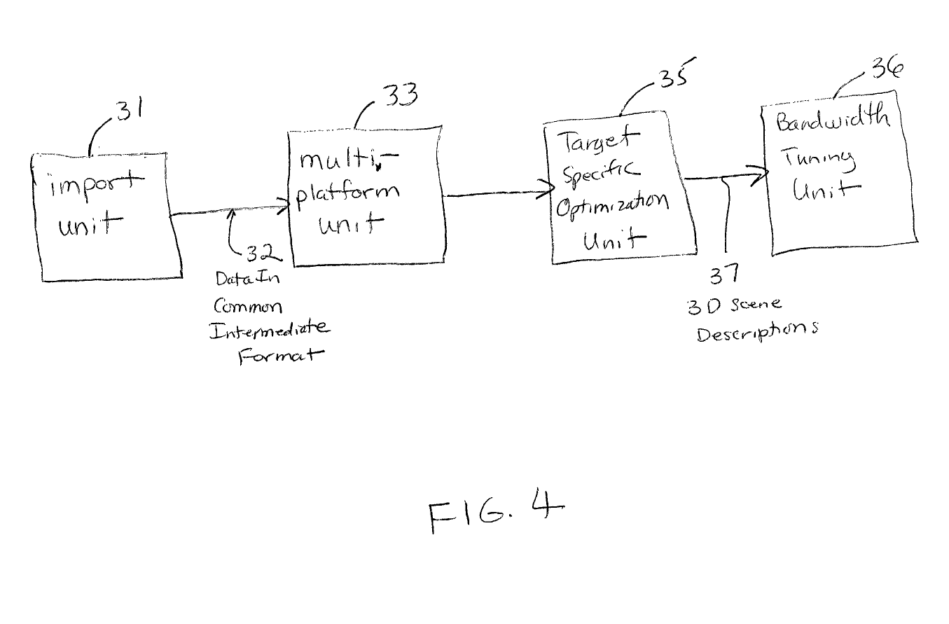

FIG. 4 illustrates an embodiment of a system for optimizing non-interactive three-dimensional image data for rendering by a computer system having a real time three-dimensional renderer. It is understood by those of skill in the art that the various units illustrated in FIG. 4 may be embodied in hardware, software, firmware or any combination of these. Additionally, those skilled in the art will appreciate that although the units are depicted as individual units, the functionality of the units may be implemented in a single unit, for example one software application, or any combination of units. It is also understood that the functions performed by the units may be embodied as computer instructions embodied in a computer usable storage medium (e.g., hard disk 509).

The optimizing encoder 13 may comprise the embodiment of FIG. 4.

The system illustrated in FIG. 4 comprises an import unit 31 communicatively coupled to a multi-platform unit 33 that is communicatively coupled to a target specific optimization unit 35 which is communicatively coupled by a bandwidth tuning unit 36.

In the context of the systems of FIG. 1 and FIG. 3 for discussion purposes, 3D Scene descriptions 12 are read in or received by the optimizing encoder 13 in the Import unit 31 and stored in a common intermediate format 32, preferably without loss of any relevant data. The purpose of this intermediate format is to represent content in a format which is suitable for many different types of targets such as player 16. Thus, the content as represented in this intermediate format may outlive any particular target platforms or media. The intermediate format comprises data necessary to render the scene examples of which are object geometry, shading information, camera description, animation paths, lighting information, and temporal animation data. In a preferred embodiment, the intermediate format provides a complete description of the content and is totally platform-independent.

The scene descriptions in the intermediate format 32, are processed by a multi-platform unit 33. The multi-platform unit 33 performs computations and/or optimizations that are common to some or all of the target platforms (for example, rendering textures from RenderMan shaders). The newly generated data together with the imported data are stored (e.g. RAM 506 in FIG. 5) for access by the target-specific optimization unit 35.

The target-specific optimization unit 35 is executed for each target platform 22. This unit takes the intermediate format scene descriptions, along with the data computed in the multi-platforn unit 33 and employs a number of optimization techniques to enhance image quality for a given platform, as will be further described below. The target specific optimization unit 35 may use the feedback information from target models extensively for optimization purposes. For example, in the system of FIG. 3, the host computer system comprises a software, hardware, or combination of both embodiment of the target-specific optimization unit 35. Feedback from the target models is conveyed through the communication couplings 23, 24 forming the feedback loop.

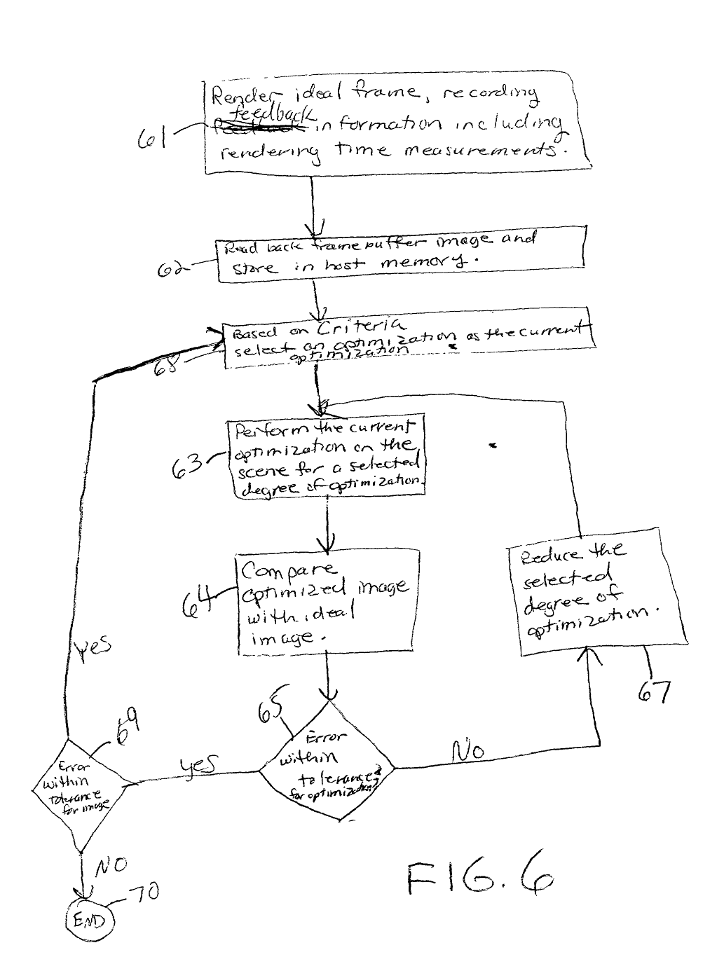

FIG. 6 illustrates an embodiment of a method of optimization for a specific computer system using feedback information. Referring also to FIG. 3, for each frame of content, an “ideal” image is rendered 61 for the target platform 22 by commanding it to render the frame using the highest quality (and generally most computationally costly) means available on the target platform. In other words, the image quality of the “ideal” image is the highest quality achievable on the target system. For example, the ideal image may be based on polygonal rendering with the highest resolution textures and greatest degree of polygonal detail available. Rendering time measurements are recorded in memory (e.g. RAM 506) of the host computer system. This ideal frame buffer image is read back and stored 62 in memory of the host computer 21 and is used as the basis for comparison for subsequent renderings of optimized versions of the same frame. Often, synthetic values will be substituted for scene parameters such as vertex colors or texel colors for gathering rendering data about the frame, such as which texels are accessed during filtering.

The Optimizing Encoder 13 then applies a number of different optimization algorithms to improve the rendering performance of each frame. Many of these algorithms are discussed in detail below. Based on criteria, an optimization is selected 68 as the current optimization to be applied. In one embodiment, the criteria is feedback information. In another embodiment, it is arbitrary selection. In another embodiment, it may be a predetermined order of performing optimizations. This current optimization is performed 63 on the scene for a selected degree of optimization. The resulting optimized image is compared 64 with the ideal image. It is determined 65 whether the optimized image is within error criteria such as an error tolerance for the current optimization or for an overall performance error criteria. The goal of each optimization is to reduce the amount of work performed by the target. The optimizer starts with the optimization applied to its maximum extent, then iteratively reduces 67 the degree of optimization until the desired image error tolerance is reached for this optimization. For example, the maximum extent of a level of detail optimization may apply the lowest level of detail to all objects in a scene. A first reduction of the degree of optimization may include increasing the level of detail. Another reduction of the degree may include applying a level of degree to only background objects. For any given specific optimization algorithm, the optimizing encoder performs the optimization in an iterative manner until an acceptable image is attained as indicated by an error criteria corresponding to the image quality which may include being within a tolerance for a particular optimization or being within an error tolerance for “ideal” image quality of the image for the particular target.

The method of FIG. 6 is discussed in the context of the system of FIG. 3 for illustrative purposes only as those of skill in the art understand that the method of FIG. 6 is not limited to operation within the system of FIG. 3.

The optimizing encoder performs 63 a current trial optimization to the frame in question. This results in a trial description, such as a scene description, for the frame which typically is different than the intermediate format scene descriptions. The trial description is communicated via communication coupling 23 to one of the target systems 27. The target system renders the trial description. For this example, assume the trial description is for at least one frame so that the target model produces a “test frame.” The test frame is returned via communication coupling 24 to the host computer 21. The Ideal frame and the test frame are compared 64 through an error measurement.

The error may be measured using simple root-mean-square (RMS) error measurement techniques, maximum pixel threshold error measurement techniques, sophisticated perceptually based error measurement techniques which comprise techniques using human eye perception thresholds for color and luminance changes, or spatial frequency based techniques, or other types of error measurements.

The error may also be judged by humans, as opposed to a numerical calculation. If, for example, an optimization causes, by chance, obscene language to appear in a frame, it would be judged as unacceptable by a human observer but might not be caught by computational error measurements with a given tolerance. As another example, slight shifts in color or complex artifacts caused by the optimizations may be manually reviewed and judged by humans rather than an automated computer system.

Based on the error measurement, be it determined numerically, heuristically or by human judgment, it is determined 65 whether the error measurement satisfies the error criteria for this optimization. For example, is the error measurement within a tolerance 65 for the current optimization. If not, the degree of optimization is reduced 67 and the current optimization is performed again. If the error measurement is within the tolerance, it is determined 69 whether the error criteria is satisfied by the error measurement being within a tolerance for the entire image in this case, a frame. If the error criteria is satisfied, (e.g., still of an acceptable level of the ideal image quality) then based on the feedback information from the rendering by the target platform, another optimization is selected 68 as the current optimization, and is performed 63 starting with its maximum extent of optimization as the first selected degree of optimization.

If the error tolerance of the ideal frame is not satisfied then the current loop of optimizing is stopped 70. One example of an action that may be taken is too increase the error tolerance and begin the optimization loop again. In the embodiment shown in FIG. 6, different optimization techniques are applied and considered one at a time. In an alternate embodiment, multiple techniques may be iterated simultaneously and/or alternately. In another embodiment, the iterative method of FIG. 6 may be performed by one or more of the multi-platform unit 33, the target-specific optimization unit 35, or the bandwidth tuning unit 36. Furthermore, during optimization, anti-piracy mechanisms such as watermarks may also be encoded into the data.

The result of the optimization unit 35 is 3D rendering information, here a series of 3D scene descriptions 37, that are ready to be encoded in the Bandwidth Tuning unit 36. However, these scene descriptions 37 may still contain high-resolution texture maps and other bandwidth-expensive primitives. In the bandwidth tuning unit 36, a bit stream is encoded for each supported physical infrastructure media's minimum bandwidth. Compression of the bit stream is achieved through techniques such as run-length encoding (RLE) of scene data, selection of appropriate texture resolution, compression of texture map data, etc. In one embodiment, the bit streams thus generated are encoded in a format designed to be streamed over the media in question (e.g., MPEG-II metadata) within the minimum bandwidth requirement. It is in the bandwidth tuning unit that, for example, texture maps may be re-sampled to meet bandwidth requirements. The bandwidth tuning unit also incorporates elements of the content not involving 3D computer graphics, such as sound, into the final bit streams 14.

The final bit stream 14 includes scene description data and commands to be transmitted to the target (e.g., player 16) to be executed by target. In a preferred embodiment, the scene description data and commands are transmitted over the Internet or other type of computer network using the MPEG-2 or MPEG-4 protocol. Note that the bit stream 14 is transmitted using the MPEG protocol but does not necessarily contain “MPEG data” in the sense of compressed two-dimensional images. The following list enumerates some of the data and commands which may be included:

Scene Description Data

Scene Element Geometry (objects, light and shadow map meshes, IBR warp meshes, etc.)

Texture maps

Lighting data

Shading data

Animation data (including object, light position and orientation paths, surface deformation animation data, shading animation data, billboard orientation data)

Scenegraph connectivity data

Audio data

Visibility data

Model LOD data

Texture Parameter data (including MIP LOD, degree of anisotropy, LOD Bias, Min/Max LOD)

Error correction data (including antialiasing, IBR error correction data)

Physics model data

Procedural Model and Texture parameters

Video elements

Special effects data

Commands

Rendering Commands

IBR image generation/application commands

Frame buffer allocation/selection commands

Frame buffer to texture copy commands

Scenegraph modification commands

Ordered subgraph rendering commands

Texture download commands

Multipass rendering commands

Special effects trigger commands

Microcode download commands

Player Management Commands

Memory allocation/free commands

Audio trigger commands

User interface control commands

Interactive content menu data

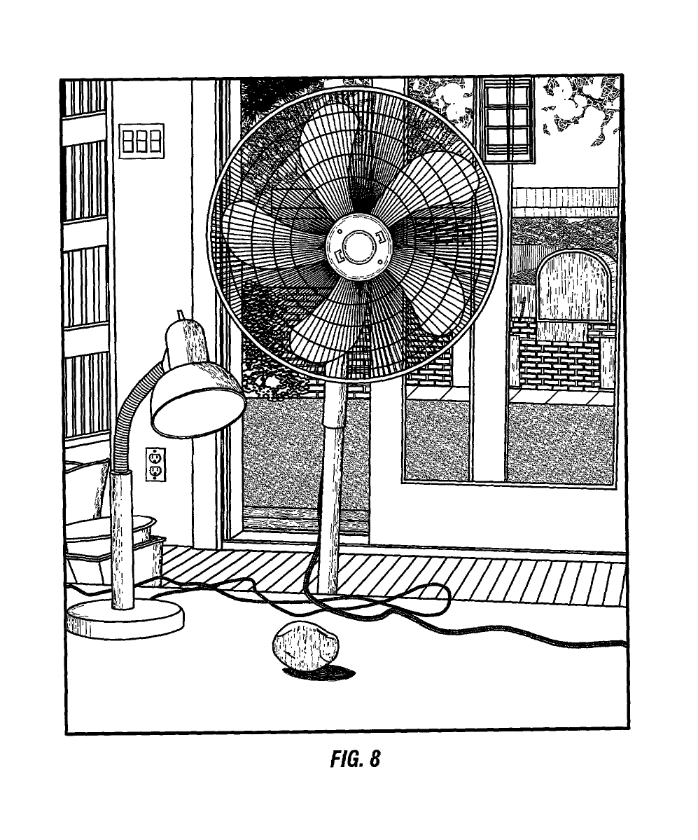

FIG. 8 is an example image from a 3D short subject. FIG. 8 is an image of a frame from a parody of Pixar's short film, Luxo Jr. In the parody, the fan plays the part of Luxo Sr., the lamp the part of Luxo Jr., and the potato the part of the ball. This example will be used to illustrate the system shown in FIG. 4. Assume that, like any traditional non-interactive 3D content, this short subject was rendered offline and then printed frame-by-frame to film and video tape for distribution.

For example, a modeler plugin may have been used to generate RIB formatted scene descriptions to be rendered using Pixar's RenderMan product. RIB content may contain multiple objects, each with geometry, shading, texturing, and transformation specifications. Objects may be grouped hierarchically and named.

Suppose, by way of example, that the short subject were being re-released using the architecture of FIG. 4. First, the original scene description files of the film from 1988 would be converted into a format which could be imported by the import unit 31 of the Optimizing Encoder 13. The Optimizing Encoder would import 31 the scene descriptions and store them in the intermediate format 32. If the scene description data does not contain temporally correlated models, the importer must correlate the model elements from frame-to-frame and perform best-fit analysis to infer animation data for the shot. Once in this format, the parody can be optimized and encoded for current and future target platforms.

Next in the optimization and encoding of the short subject is multi-platform processing performed by the multi-platform optimization unit 33. In this particular example, the RenderMan shaders abstractly describing the texture of the potato are converted into a more manageable format, for example a set of texture maps and a simple description of how to combine them to produce the correct final result. Tthe multi-platform optimization unit 33 also subdivides the long, complex cords of the fan and the lamp into smaller segments for easier culling, as well as computing bounding volumes and performing a number of other operations on the scene hierarchy to make it more suitable for real time rendering. This and other multi-platform data is then passed along with the scene descriptions 32 to the target-specific optimization unit 35. Suppose that the platform being targeted for distribution of the short subject is the Sony Playstation II. The Optimizing Encoder has a palette of different optimization algorithms—techniques that can be used to more efficiently render scenes—that apply to certain target platforms. For this example, suppose that the Optimizing Encoder has three optimization algorithmns that apply to the Playstation II: Visibility determination, Model LOD selection, and Image Based Rendering.

For the frame in FIG. 8, the Target-Specific Optimization unit 35 of the Optimizing Encoder first renders 61 the scene using the highest possible quality (and correspondingly least efficient) method available on the Playstation II. It can do this because it has a very accurate model of the Playstation 1I (an actual Playstation II, in fact) accessible by the Optimizing Encoder's host computer. Suppose that frame takes 500 ms to render, which is vastly greater than the allowed 16.6 ms. The rendered image is read 62 back to the host computer and is referred to as the “ideal” image—the highest quality image achievable on the Playstation 1I. This image is the standard by which all subsequently rendered images of this frame will be judged.

The Optimizing Encoder then begins applying optimization algorithms from the Playstation II-specific palette in accordance with steps 63, 64, 65, 68, 67, 69. The first optimization applied is Visibility Determination, in which each object in the scene hierarchy is tested to see if it is visible or not. In this specific embodiment of Visibility Determination, there are two ways for an object to be invisible: outside the frustum (off camera) or occluded by another object. For frustum testing, for each object, the host computer 21 first tests the bounding volume of the object to determine if it is entirely inside, entirely outside or partially inside the view frustum. For objects that are partially inside, the host computer 21 instructs the target model 22, for example, a Playstation II model, to render each object individually into a cleared frame buffer, and reads back and re-clears the frame buffer after each object has been rendered. If any pixels have been changed by the object in question, it is considered visible. If not, it is considered outside the frustum. Next, the host computer 21 instructs the target model 22 to render all of the objects deemed inside the frustum and compares the resulting image against the Ideal image. They should match exactly. Then, for each object inside the frustum, the scene is rendered without that object. If the resulting image is within an acceptable tolerance of the Ideal image, that object is considered occluded and is excluded from subsequent renders. For the case of the frame shown in FIG. 8, off-camera objects include segments of the cords that are outside the frustum. Occluded objects include the fan's motor and base and sections of the lamp's shade.

The second optimization employed is Level Of Detail selection. Using the Playstation II model, the Optimizing Encoder renders each visible object starting with the coarsest level of detail, progressing to the finer LODs until the rendered image of that object is within an acceptable tolerance of the Ideal image. For this example consider the grille on the fan. At the finest Level of Detail, the grille is composed of many cylindrical wires modeled with polygons or patches in the shape of the grille. This degree of detail is unnecessary for the frame in question because the wires of the grille are far from the camera. The Optimizing Encoder can select an LOD for the grille that consists, for example, of a convex hull of the shape of the entire grille with a texture-map with transparency of the wire pattern applied to it. Such coarser LODs can either be supplied explicitly by the content creators or can be derived by the multi-platform unit 33.

The third optimization employed is Image Based Rendering. Since the example frame is from the middle of the short subject, many elements of the scene have not changed substantially from previous frames. A good example of an element with a high degree of frame-to-frame coherency is background consisting of the door and outside scene. Because the camera is stationary in the short subject, this scene element was rendered at the very beginning of the shot and the resultant image was captured to texture memory and that image has been used instead of the underlying polygonal models ever since. The Optimizing Encoder determines using the method of FIG. 6 if it is still safe to use the image-based version of the background by comparing 64 it to the Ideal image for this frame, and since there is no appreciable difference, the image-based version is selected. A more interesting case for Image Based Rendering is the base plate of the lamp. In the short subject, the lamp hops and shimmies around quite a bit, but remains mostly stationary for short periods (1-3 seconds). The example frame is during one of those periods. The base element can be captured in an image, which can be re-used during those frames, as long as the lighting and shadows falling on it don't change substantially. The Optimizing Encoder compares the image-based version of the base to the Ideal, and then decides if the image is acceptable as-is, can be corrected by inserting a slight error-correction signal such as “touch-up” pixels or warping commands into the stream, or must be discarded and re-rendered from polygons or patches.

Once all three of these optimizations have been applied, the Optimizing Encoder can judge whether or not the desired performance has been reached by rendering the image as the player would, given the specific visibility, LOD, and IBR parameters determined during steps 63, 64, 65, 68. 67, 69. If the desired performance has not 70 been reached, in one example, a global bias can be used to cause rendering with a larger error tolerance, resulting in a sacrifice of image quality for performance. If the error tolerance is changed, the three optimizations are repeated with the new tolerance, then the performance is measured again, and the process is repeated until an error tolerance is found that meets the performance requirements.

Once the Target-Specific Optimization unit 35 has been completed for every frame and the desired performance has been achieved for the Playstation II, the resulting description of the short subject 37 is processed by the Bandwidth Tuning unit 36. Suppose that it is intended to distribute the short subject by two media: 1 Mb/sec wireless network, and by DVD, which has an effective bandwidth of 10 Mb/sec. These bandwidths impose two very different limitations on the amount of data that can be fed to the target per frame. In this example of using player 16, bandwidth tuning 36 is first performed for the DVD distribution. At 10 Mb/sec, because the short subject is a fairly simple animation by modern standards, it is determined that the peak bandwidth required is 1.4 Mb/sec (for the sake of example), which does not exceed the limitation of 10 Mb/sec. The short subject is encoded as a series of data and commands in an MPEG2-compatible stream, which is slated to be mastered onto CDs.

However, if this stream were to be loaded onto a server for distribution over a 1 Mb/sec network, the viewing experience would be extremely unpleasant because information would not be available for proper rendering. Therefore, the same description 36 of the short subject is processed again with a bandwidth limitation of 1 Mb/sec. It is determined that, as initially encoded, the short subject requires a minimum of 1.4 Mb/sec, which exceeds the 1 Mb/sec limitation. The Optimizing Encoder then reduces the bandwidth requirement by resampling texture maps to lower resolution, possibly eliminating fine LODs requiring a great deal of bandwidth, and re-scheduling the stream where possible to “smooth out” peak events in the stream. Note that for media subject to varying bandwidth availability (eg. cable modems subject to traffic congestion), a realistic bandwidth is used for the optimizations, as opposed to the theoretical peak bandwidth of the medium.

As a final step of the Bandwidth Tuning unit 36, a “sanity” check is performed, playing back the final stream on the model 22 of the Playstation II to make sure that target rendering performance is maintained and that the maximum realistic bandwidth of the current media is not exceeded.

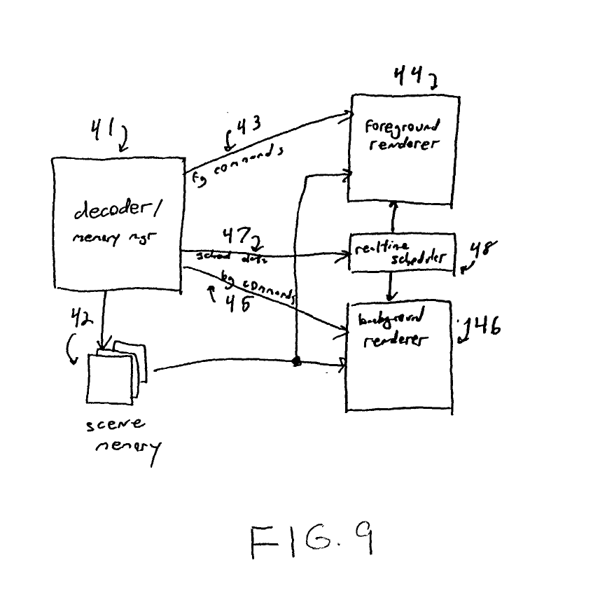

FIG. 9 is a block diagram illustrating software components of one embodiment of a player 16. The incoming bit stream 14 is decoded by the Decoder/Memory Manager 41. The decoder separates the bit stream into its component streams including scene data 42, scheduling data 47, foreground commands 43, background commands 45, and memory management commands, as well as non-graphics streams such as audio. All of these streams are decoded while maintaining synchronization. In its memory management capacity, the decoder/memory manager 41 sorts the incoming data objects into memory pools by shots within the content or by shot-group. This allows for rapid bulk discard of data once it is no longer needed (e.g., if a character makes its final appearance in a program). The decoder also handles transport control inputs such play, pause, fast forward, etc. from the viewer. The Foreground Renderer 44 is responsible for drawing the next frame to be displayed. In this embodiment, it must finish rendering each frame in-time for each display event (e.g., the vertical retrace). It may use elements drawn over the last few frames by the Background Renderer 46. The Background Renderer works on drawing scene elements which will be displayed in the future, for example those which may take more than one frame-time to render. The two renderers are coordinated by the Real time Scheduler 48. The real time scheduler takes scheduling data encoded in the bit stream and allocates processing resources of the hardware portion of the Player 16 to the renderers.

Within the embodiment of a system illustrated in FIG. 1, the optimizing encoder 13 can use any number of graphics processes to optimize the bit stream 14 for specific Players 16 and/or physical infrastructures 15. Optimization typically means higher image quality and/or lower bandwidth required for the bit stream 14. The following are some examples of graphics processes which may be used by optimizing encoder 13. It should be noted that not all of these techniques are appropriate for all target platforms. The Optimizing encoder 13 uses them selectively as appropriate. Before discussing the optimizations themselves, categories of optimizations are discussed next.

The various optimizations discussed may be applied in various combinations and sequences in order to optimize the non-interactive three-dimensional data for rendering by three-dimensional real-time renderers. Additionally, the optimizations discussed fall into different categories of optimizations. General categories include scene management and rendering scheduling, geometry optimizations, shading optimizations, and animation optimizations. Optimizations may fall into more than one category.

An example of a specific category is microcode generation that includes the following computations and encodings: texture parameter (e.g., MIP LOD, degree of anisotropy) calculation, lighting parameter (e.g., specular threshold) calculation, microcode download scheduling, billboard precomputation.

Another category includes those optimizations involving injecting corrective data such as IBR warp mesh computations, IBR error metric computation, procedural model characterization, edge antialiasing, and physics model error correction.

Another category includes those optimizations based on the scheduling of object rendering and the reordering of objects to be rendered such as guaranteed frame-rate synchronization, conventional IBR or background rendering scheduling, and load-dependent texture paging scheduling.

Image based rendering techniques include IBR warp mesh computation, IBR projected bounding volume computation, and IBR error metric computation.

Another category includes those optimizations based on the deletion of unused data or the delaying of rendering of data such as visibility determinations based on occlusion and/or frustum, model level of detail calculation, and unused texel exclusion.

Another category includes those optimizations based on pre-computing runtime parameters such as guaranteed frame-rate synchronization, visibility determination (occlusion and frustum), model level of detail calculation, Texture Parameter (e.g., MIP LOD, degree of anisotropy) calculation, Lighting Parameter (e.g., specular threshold) calculation, IBR Warp Mesh computation, IBR Projected Bounding Volume computation, IBR Error Metric computation, Conventional/IBR/Background rendering scheduling, Billboard Precomputation, Procedural Model characterization, Edge Antialiasing, and state and mode sorting

Another category of optimization involves optimizing assets (the platform-independent source data contained in the Intermediate format) such as in Unused Texel Exclusion, Texture Sampling optimization and Edge Antialiasing.

Another category of optimizations involves texture map creation including Texture Parameter (e.g., MIP LOD, degree of anisotropy) calculation, Lighting Parameter (e.g., specular threshold) calculation, Unused Texel Exclusion, and Texture Sampling optimization.

Another category of optimizations involves shading computations such as in Texture Parameter (e.g., MIP LOD, degree of anisotropy) calculation, Lighting Parameter (e.g., specular threshold) calculation, IBR warp mesh computation, texture sampling optimization, procedural model characterization, edge antialiasing, and physics model error correction.

Another category of optimizations involves manipulation, such as bycreation, modification, selection or elimination, of object geometry and may affect which pixels are covered by objects within the image optimizations visibility determination based upon occlusion and/or frustum, model level of detail calculation, IBR warp mesh computation, billboard precomputation, procedural model characterization, edge antialiasing, and physics model error correction.

Another category of optimizations involving compression includes visibility determination based upon occlusion and/or frustum, model level of detail calculation, IBR warp mesh computation, unused texel exclusion, procedural model characterization, and physics model error correction.

The first such optimization is Guaranteed Frame Rate. One problem with interactive real time 3D graphics is guaranteeing a constant frame rate regardless of a user's actions. Tools such as IRIS Performer's DTR can attempt to reduce detail based upon system load, but dropped frames are commonplace and apparently no scientific method for guaranteeing a 100% constant frame rate without globally sacrificing detail exists in the prior art. (Rohlf, Helman “IRIS Performer: a high performance multiprocessing toolkit for real time graphics” Siggraph 1994).

While the problem is not so severe for non-interactive content, in order to have real time playback of content, the content must be rendered quickly enough to support the playback rate of the content. For example, if the content is to be shown on NTSC television, which has a refresh rate of 16.6 milliseconds, then in one embodiment, each frame of content is rendered in 16.6 milliseconds or less, thus guaranteeing a frame rate adequate for the display. Note that this is not the only approach. For example, in another embodiment, frames could be designed to be rendered in 100 milliseconds. However, in this case, buffering will be required to meet the 16.6 millisecond refresh rate. To achieve the goal of a solid frame rate, the Optimizing encoder employs a number of techniques (preferably including some or all of those described below) and iteratively renders the scenes on the target subsystem 22 to establish accurate frame times. This allows the Optimizing Compiler to certify that the player will never “drop a frame” for a given piece of content, without tuning for the worst case, as with real time game engines. In the context of FIG. 4, the rendering time required by the foreground renderer 44 and background renderer 46 is determined via the feedback path 24, and encoded into the bit stream for predictable scheduling on the player 16. The Real time Scheduler 48 uses this scheduling data to keep the renderers 44, 46 synchronized and within their time budgets in order to achieve the frame rate required by the player 16. The scheduling data may also include factors to allow for bit stream decoding time as well as non-graphics consumers of CPU time—such as network management, audio processing and user interface control—during playback.

The second optimization is reducing, or even eliminating, the need for object visibility computations at run-time on the player 16. Traditional real time interactive graphics applications utilize culling techniques to improve rendering efficiency. Culling, which selects which objects to draw based upon visibility, is a substantial computational burden and also requires enlarged memory usage to be performed efficiently (bounding volumes must be stored). Most real time culling algorithms are not generalized for all types of visibility culling, including frustum, occlusion by static objects, and occlusion by dynamic objects. This is because different interactive applications have very specific culling needs. For a game such as Quake, consisting of many separate rooms connected by portals such as doors, a precomputed visibility graph such as a Binary Space Partitioning tree may be appropriate because of the large depth complexity of the overall world. For a large-area flight simulator, real-time frustum culling may be best suited because of the low depth complexity and total freedom of movement throughout the large area. Likewise, different shots of a single CGI movie may have very different characteristics mandating a variety of culling approaches to be effectively culled in real-time.

The Optimizing encoder 13 determines the visibility per-frame for each object in the scene, preferably in a hierarchical manner, and encodes that data into the bit stream, for example as was described previously in the example of FIG. 8. Most interactive rendering engines are currently limited to frustum culling or special-case BSP-type occlusion culling. With this approach, fully generalized visibility determination is performed to minimize over-rendering while preserving accuracy. In one embodiment, the Optimizing encoder uses a combination of visibility computations, such as bounding volume visibility tests, as well as using the target platform 22's rendering engine during optimization for more complex or platform-dependent computations such as occlusion culling.

In another embodiment, the target platform 22's graphics pipeline is utilized during optimization for visibility determination by assigning each object a unique ID, which is stored in the vertex colors. After the scene is rendered by the target subsystem 22 with these synthetic colors and texturing disabled, the frame buffer is read back and analyzed to determine which colors (object IDs) contribute to the frame. The objects may then be prioritized for rendering purposes as indicated by an organization of the object IDs.

Additionally, the Optimizing encoder can determine if any surfaces or objects are never seen during the program and can delete those surfaces or objects from the bit stream to conserve bandwidth.

The third optimization is reducing or even eliminating the need for object Level Of Detail (LOD) computations at run-time on the player 16, also previously discussed in the example of FIG. 8. A variety of real time methods for rendering models at different Levels Of Detail exist in the art, ranging from storing several pre-generated versions of models to adaptively decimating models on the fly. It is difficult to ideally generate or select LODs in interactive applications because the process depends upon viewing angles, which can be arbitrary. Most real time LOD selection algorithms use simple ranges to select LODs, a technique that does not take viewing angle into account. For even the most sophisticated LOD selection algorithms, it is unfeasible computationally to perform the comprehensive frame buffer analysis necessary for truly perceptual LOD selection in real time.

For the non-interactive case, the Optimizing encoder computes the appropriate Level Of Detail for each multiresolution object in the scene per-frame and encodes that data into the bit stream. This optimization allows the use of implicit/dynamic LOD ranges to simplify content creation and improve rendering efficiency while maintaining maximum quality. The Optimizing encoder can render a frame multiple times with the given object at different LODs and determine the coarsest LOD that can be used without sacrificing quality. In one embodiment, it does this by rendering at a particular LOD to the region of the frame buffer including the object in question, objects which occlude it, and objects it occludes, and then comparing the rendered pixel values with the corresponding pixels from the Ideal frame. This process is repeated for each available LOD, to determine the error of each LOD relative to the finest LOD. These error measurements, preferably along with object priority rankings, are used to choose the most appropriate LOD. This technique is especially useful for objects that are more complex when viewed from some directions than others—a condition which is difficult to handle efficiently with explicit ranges.

When a texture map is applied to an object in a scene, the graphics hardware performs a filtering operation to map the texels within each pixel's footprint to a single pixel color. The most common types of texture filtering use MIP-mapping, in which the base texture is prefiltered into a series of LODs, each of which having ¼as many texels as the LOD preceding it. During the rasterization process, the LOD or LODs most closely corresponding to the footprint size (in texels) of the pixel is chosen, and the texture filter takes samples (4 for bilinear, 8 for trilinear, and typically up to 32 samples for anisotropic filtering) from the designated LODs to generate the final result. If the pixel footprint corresponds to one or more texels, the texture is said to be “minified” for that pixel. If the footprint corresponds to less than one texel, the texture is said to be “magnified” for that pixel. When textures become magnified, it means there is insufficient resolution in the texture for the magnified region, and produces undesirable visual results (the texture begins to look blocky as the individual texels span more than one pixel). Magnification nonetheless occurs in real time applications because there is a) insufficient resolution in the source imagery, or b) insufficient texture memory available to store a higher-resolution texture map. There is nothing that can be done about the former except acquiring higher fidelity source data (e.g., buying a better camera), unless the texture is procedurally generated, and can be regenerated with higher resolution. In the latter case, it may be possible to make better use of available texture memory. For interactive applications, though, it is difficult to know apriori which objects or portions of objects the viewer will see close enough to cause magnification with a given texture memory allocation.

The fourth optimization is precalculation of texture-mapping parameters by the Optimizing encoder. On some target platforms, there is no direct hardware-supported computation of parameters such as MIP LOD or Degree of Anisotropy. Other target platforms may have support for calculation of low-level texture parameters, but incur performance penalties when other modes or parameters are improperly set. An example of such a parameter is Maximum Degree of Anisotropy. For those targets, in step 35, the Optimizing Encoder computes those and other texture-mapping parameters per-frame at whatever granularity is prudent (e.g., per-vertex, per-object, etc.) and encodes the results in the bit stream. In one approach, these parameters are computed using well-known methods in the host computer 21. In another approach, they are computed by the target platform 22 microcode and read back to and stored by the host computer 21. This can improve rendering quality by unburdening the processors on the target platform. For platforms which compute most texture parameters directly, the Optimizing Encoder can utilize a software model or iterative analysis to determine if application-specified parameters such as Maximum Degree of Anisotropy are optimally specified. The Bandwidth Tuning unit 36 may eliminate all or part of the texture parameter data if it will require excessive bandwidth, and then must reduce the level of detail or bias the error tolerance and re-invoke parts of step 35 to reach adequate rendering performance within the bandwidth constraint.

The fifth optimization is precomputation of lighting parameters by the Optimizing encoder. Lighting has been implemented extensively in real time graphics rendering hardware. Historically, per-vertex lighting, in which lighting parameters are computed for object vertices and linearly interpolated across triangles, is the most common form of hardware-accelerated lighting. More recently, fragment lighting has begun to appear in hardware products, in which vertex normals are interpolated across triangles and lighting is computed from the interpolated normals and x, y, z positions of fragments, which lends more realism to lighting of polygonal models. Fragment lighting is most often achieved using one or more textures used as lookup tables in simulating various characteristics of lights or materials. Textures are also often used as bump-maps or normal-maps, which affect the normal vectors used in lighting calculations. Per-vertex lighting is frequently implemented in the form of microcode, where the lighting computations share the same computational units as the rest of the per-vertex calculations (e.g., transformations). For certain lighting configurations, such as local lights with nonzero specular components, evaluation of the lighting equation can be expensive. In such cases, the results of the computations may be degenerate. For example, for a spherical mesh lit with a single local specular light, between 50 and 99 percent of the vertices may be assigned a specular component of zero. For interactive graphics, it is unfeasible to recoup any of the performance consumed by such degenerate lighting calculations because of the computational overhead that would be consumed determining which vertices are likely to be degenerate.

Lighting is frequently an expensive operation that costs geometry performance on real time rendering hardware. By precomputing certain lighting parameters, the Optimizing encoder can dramatically improve lighting performance and indirectly improve rendering quality by freeing up computational resources. One such parameter, which can yield good results, is computing whether the specular component of a local light's impact on a vertex is below a threshold. In one approach, the Optimizing encoder evaluates the lighting equation in the host computer 21. Alternately, if supported by the target platform 22, the optimizing encoder records 24 the results of the target platform 22's evaluation of the lighting equation. A third method for obtaining the results of the lighting equation is rendering one or more images of the object in question with well defined lighting parameters, reading back the frame buffer images and determining which polygons have significant lighting contributions. The Optimizing encoder can compute such parameters per-frame at whatever granularity is prudent (e.g., per-light-per-vertex, per-light-per-object, etc.) and encode the results in the bit stream. Thus, the task of determining in real time which vertices are degenerate on the player can be reduced to a single memory or register access per-vertex, which is feasible for implementation in microcode. On platforms where custom microcode, such as Vertex Shaders or Pixel Shaders can be employed, the optimizing encoder may generate optimized microcode for special-case lighting. This is especially necessary when custom microcode is already in use on a particular model, as generalized lighting is inefficient for many combinations of light and material parameters.

There has been much discussion on the topic of Image Based Rendering (IBR) in the art (e.g., Torborg, Kajiya: SIGGRAPH '96 proceedings p. 353; Lengel, Snyder: SIGGRAPH '97 proceedings p. 233; Snyder, Lengel: SIGGRAPH '98 proceedings p. 219), yet few products have appeared using IBR techniques in real time. Roughly speaking, IBR uses 2D images to approximate or model 3D objects. Much of the relevant art in the field of Image Based Rendering proposes special hardware architectures. Implementing IBR in real time applications requires accurately determining when a scene element needs to be rendered using conventional surface rendering, and when it can be rendered from an image-based representation. Also, deriving correct warping operations can be computationally expensive for real time applications. Additionally, in order to maximize the effectiveness of rendering interactive scenes using image-based techniques, the scenes must be broken down (or “factored”) into many separately composited elements, which can consume a large amount of graphics memory.

The sixth optimization is precomputation of IBR warp meshes by the Optimizing encoder. For target platforms in which IBR is facilitated by drawing surfaces with the source frame as a texture map, the Optimizing encoder identifies optimal points in texture-space (source frame) and in object-space (destination frame) for the warp mesh.

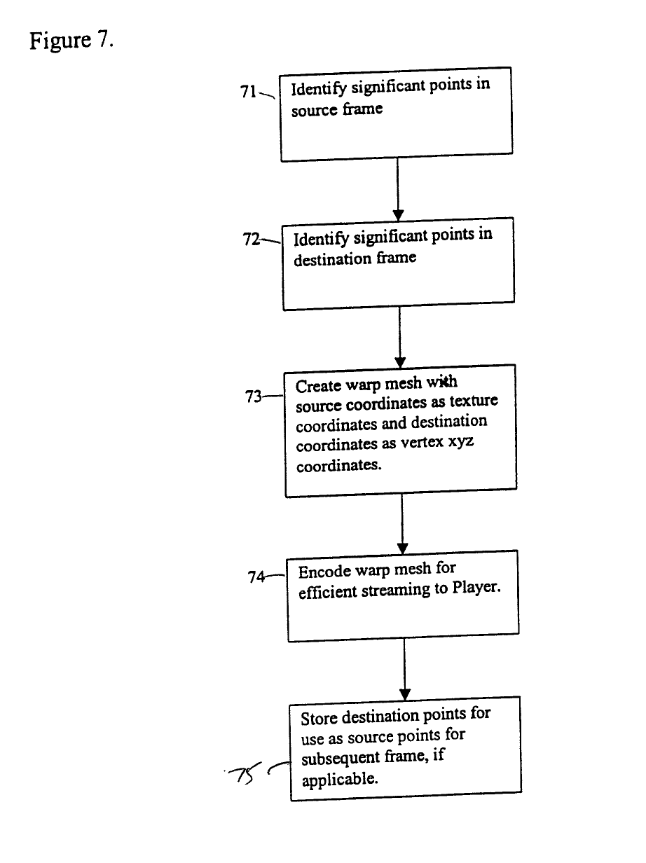

FIG. 7 describes one embodiment of this process. FIG. 7 illustrates an embodiment of a method for computing warp mesh for Image Based Rendering. Significant points include points in the image that will result in discontinuities in the mapping from source to destination frames. These discontinuities are usually caused by steep variations in projected depth (parallax) or by the viewing frustum, as geometry may move in and out of the viewing volume as the viewpoint changes or objects move within the scene. Once the significant points in the source frame have been identified 71 (for example using methods such as depth buffer analysis or direct analysis of scene surface geometry), they may be treated as texture coordinates for applying the source frame buffer image as a texture map. Because the Optimizing encoder has time to perform extensive analysis on the data, the significant points are identified from the scene source data for each frame, even though warp meshes derived from these points may be applied repeatedly in a recursive Image Based Rendering process. The same process is used to identify 72 significant points in the destination frame. It is desirable for the source and destination points to correspond, where possible, to the same locations in world coordinates. This is not possible for points that correspond to geometry that is invisible in one of the two frames. The Optimizing encoder then constructs 73 a warp mesh using the source points as texture coordinates and destination points as vertex coordinates. These points (vertex and texture coordinates) are encoded 74 in the bit stream, preferably per-frame, and used by the player 16 to efficiently perform IBR. The destination significant points may also be saved 75 for use as the source frame if the next frame is to be rendered using IBR. This optimization applies both to surface-based models and to light and shadow maps, which can also be efficiently rendered (if dynamic) using IBR techniques. In this case, the result of the image based rendering is a texture map that will be applied to arbitrary geometry, rather than a screen space image. The destination points, therefore correspond to texel coordinates in the unmapped light/shadow map instead of coordinates that will be affinely projected into screen space.

The seventh optimization is precomputation of Projected Bounding Volumes of objects by the Optimizing encoder. The Projected Bounding Volume is useful on target platforms, which directly support affine warping operations. The Optimizing encoder determines the bounding volume for the object in question, projects the extrema of that bounding volume, and then can either encode that data directly in the bit stream or compute the necessary target-specific warping parameters directly and encode that data in the bit stream. This differs from interactive approaches such as those offered by (See Lengel, Snyder: Siggraph '97 proceedings p. 233) in that a truly optimal affine transform may be computed per-object, per-frame using arbitrarily complex bounding volumes (as opposed to simple bounding slabs).

The eighth optimization is computation of error metrics for Image Based Rendering by the Optimizing encoder. When a frame is rendered using IBR techniques, errors may occur due to resampling artifacts, parallax, or vagaries of the technique being used. The Optimizing encoder renders the same frame using both IBR and straightforward surface-based techniques and then compares the two frames to determine which pixels or surfaces are in error. This data can then be used to correct the errors in the IBR-rendered frame on the player. The Optimizing encoder chooses an appropriate error correction technique for the target platform and encodes the necessary error correction data (e.g., lists of pixels or polygons to touch up) into the bit stream to be applied by the player. Because errors can be corrected in this manner, it is not necessary to factor the scene into as many layers as with interactive IBR techniques, resulting in a savings of graphics memory. If there are too many erroneous pixels in the IBR image for efficient error correction, the Optimizing encoder may instead schedule conventional rendering for the scene element in question on the erroneous frame. As with optimization 6, this optimization applies not only to frames rendered from scene objects, but also to dynamic light and shadow maps. For light and shadow maps, errors exceeding the tolerance may be corrected by corrective geometry, for example if the maps are rendered from a surface representation, or by inclusion of corrective texels in the bit stream. For the case in which the entire map is discarded, the entire texture is included in the bit stream instead.

The ninth optimization is scheduling by the Optimizing encoder, for example scheduling of IBR-rendered, polygon-rendered and background-rendering frames. The Optimizing encoder uses data about rendering times, IBR errors and any other pertinent data for the current and future frames to decide which frames should be conventionally rendered or IBR-rendered, and which scene elements the Background Renderer should render at which times. The Optimizing encoder first attempts to schedule rendering such that the target frame rate is achieved without sacrificing quality. If this is impossible, the Optimizing encoder can re-invoke other optimizations with tighter performance constraints or increase the IBR error tolerance so that more IBR frames are scheduled. These decisions are encoded into the bit stream as explicit rendering commands, which are fed to the foreground and background renderers. As with optimizations 6 and 8, this optimization applies to scheduling rendering of light and shadow maps, which will generally be rendered by the background renderer.

The tenth optimization is the exclusion from the bit stream of unused texels by the Optimizing encoder. In one approach, the Optimizing encoder maintains “dirty bits” for texels (of each Multum In Parvo (MIP) level of texture maps used in a program. These bits keep track of when, if ever, the texels are accessed by the texture filters on the target platform during the program. This information is obtained by substituting synthetic texel indices for the actual texels in texture maps used by the object in question. To obtain mipmap dirty bits, the object is then rendered once with point sampling enabled and an LOD bias setting of −0.5. The frame buffer is read back to the host, then the object is re-rendered with an LOD bias setting of 0.5, and the resulting image is read back to the host. The dirty bits are then updated for all texels indexed by the two resultant frame buffer images. Those familiar with OpenGL will understand the impact of LOD bias on mip-level selection. On graphics architectures other than OpenGL, equivalent mechanisms, if available, may be used. The two pass approach is preferred for textures filtered with trilinear filtering or any other filtering method which accesses multiple MIP levels. The dirty bit information is used for scheduling when the texels are inserted in the bit stream or for deleting those texels from the bit stream entirely if they are never accessed by the filters. A simplified version of this technique may be used for magnified or bilinearly-filtered textures, as only one texture level is accessed.

The eleventh optimization is optimizing texture maps for efficient sampling. In a method similar to optimization 10, the Optimizing encoder determines which texels of a texture map are magnified during a scene. Because excessive texture magnification is often visibly offensive, the Optimizing encoder can attempt to warp the texture image in such a way as to add texels to the geometry that results in the magnification without increasing bandwidth requirements. This is only possible if other areas of the texture are sufficiently minified over the course of the program to allow texels to be “stolen” for use in the magnified section. The Optimizing encoder modifies the texture coordinates of the geometry using the texture map to invert the warp on the image so that the texture coordinates correspond to the modified texture. The new texture and texture coordinates replace their original unwarped counterparts in the bit stream.

The twelfth optimization is precomputation of billboard orientation by the Optimizing encoder. Billboards, which are models (typically planar) that automatically orient themselves in the 3D scene such that they face the viewer, are commonly used as an inexpensive, approximate representation of 3D models and for rendering of special effects such as explosions. Computing the billboard angles and corresponding matrix for each billboard can be costly, particularly for large numbers of billboards. APIs such as IRIS Performer can optimize billboard computations by grouping billboards, but excessive billboard grouping can result in incorrect billboard alignment. Additionally, stateless (meaning only data from the current frame is used in calculations) billboard algorithms produce artifacts in the form of off-axis rotations for billboards which pivot about a point (as opposed to a line) when the viewer passes close to the billboard. The Optimizing Encoder may also convert billboards to stationary objects if camera movements are limited for a particular shot, or to 2D sprites if either the camera does not “roll” or the billboarded objects are degenerate in the view axis (eg. textured points).

The computations necessary to properly orient the billboards can be costly when performed at runtime, and efficient runtime algorithms often break down and cause perceptible artifacts when the viewer passes close to the billboard center. The Optimizing encoder performs the necessary computations during optimization, including using its knowledge about the camera path to eliminate computational artifacts. The billboard equations are well known. They compute the correct billboard orientation per-frame and encode the data in the bit stream as animation data for use by the player in orienting the geometry as a billboard.

The thirteenth optimization is characterization of procedural models by the Optimizing encoder. Procedural models, such as particle systems or inverse-kinematic descriptions of model movement, allow for reduced bandwidth for complex characters or special effects. A popular and effective technique for computing the motion of objects such as water drops, sparks or large systems of objects in general is the use of particle systems. Particle systems define a base particle, such as an individual spark, which can be rendered according to some parametric description. For the case of the spark, such parameters might include position, velocity and temperature. Correspondingly, the spark might be rendered as a streak polygon with a certain position, orientation, length, and color distribution. The system is typically comprised of some number of particles (can be very large-hundreds of thousands), and a computational model, which computes the status of each particle and sets the parameters for each particle to be rendered. When the particles are rendered, some are likely to be occluded by other objects in the scene even other particles. For the case of the sparks, they may emanate from a welding torch behind a construction fence, and depending on the viewer's position, then as many as all or as few as none of the sparks may be visible in a given frame. Both the rendering and computational resources used by occluded sparks in such a system are wasted. It is difficult to recover this performance in interactive applications, however, because the viewpoint is arbitrary to some degree, and the computational model for particles that are currently occluded but may become visible must be updated so that the particle parameters can be specified correctly when the particle becomes visible.

Another type of procedural modeling technique is Inverse Kinematics, in which a 3D object is represented as visible surfaces (e.g., “skin”), with positions, curvature, normals, etc. controlled by an invisible skeleton. Once an object (e.g., a human) has been modeled in this way, an animator can manipulate the “bones” of the skeleton, rather than the vertices or control points that comprise the skin. This method has proven to be very user-friendly and is supported by many commercial modeling and animation programs, such as Alias Studio. In addition to being user-friendly, storing key frames for the skeleton is a much more compact representation than storing the corresponding per-frame vertex coordinates, especially for complex models.

By using the same algorithms and random number generators, the Optimizing encoder can compute useful data such as particle visibility (for limiting particle computations in addition to particle rendering), particle system or character bounding volumes, etc. For particle systems, the Optimizing encoder can keep track of how its optimizations affect the behavior of the random number generators to keep consistency between the optimization data and the optimized particle system. The Optimizing encoder encodes these procedural model characterizations in the bit stream. It may also encode the particle parameter data necessary to correctly resume the animation of particles that become visible after being hidden.

An additional optimization possible for animated characters that use skeletal animation is bone simplification, in which the dynamic model for the skeleton is solved for each particular frame or group of frames, and the “bones” in the skeleton that do not have a significant contribution to the animation (determined by comparing the actual bone contribution to a predetermined threshold value ) are removed from the scene, or the contribution of multiple bones can be reduced to a single, aggregate bone. By making use of the predetermined viewpoint and animation in each shot, the Optimizing encoder can pre-compute the right skeleton detail for each shot without any extra runtime processor overhead.

The fourteenth optimization is application of antialiasing to surface edges identified by the Optimizing encoder. Antialiasing (AA) is an important technique to make 3D computer graphics scenes believable and realistic. Antialiasing, which removes serves to remove jagged and flickering edges from 3D models, has been implemented extensively. Two main types of antialiasing techniques have emerged in real time graphics systems: full-scene and edge/line antialiasing. Full-scene antialiasing techniques utilize supersampling techniques utilizing an enlarged frame buffer and texturing hardware or specialized multi-sampling hardware. Very sophisticated antialiasing algorithms such as stochastic sampling have been implemented in ray-tracing systems or very high-end real-time graphics computers. Full-scene antialiasing is a very generally useful type of antialiasing because it works equally well for all types of geometric content and requires little or no application intervention to achieve good results. Full-scene antialiasing techniques usually require substantially more (as much as 4× for 4 subsamples) frame buffer memory than would needed for unantialiased rendering at the same resolution, largely because depth (Z) is stored for all samples. Full-scene AA techniques also incur a pixel-fill performance cost, and are rarely implemented on low-cost graphics systems. Edge/Line antialiasing is used primarily for CAD applications for antialiased lines. Edge/line AA hardware performs simple pixel coverage (opacity) calculations for lines or triangle edges at scan-conversion time. Line AA is traditionally most useful for visualization of wireframe models. Edge AA is usually implemented directly in special-purpose CAD hardware or algorithmically, rendering each polygon twice: once as a filled polygon, and once as a collection of AA lines using the same vertices as the polygon. This technique can be impractical because it requires back-to-front sorting of all surfaces in the scene to prevent severe artifacts. The combination of rendering each vertex twice and sorting makes traditional Edge AA unfeasible at real time rates for scenes of reasonable complexity. While less generally useful than full-scene antialiasing, edge/line AA is inexpensive to implement in hardware.

For target platforms where full-scene antialiasing is unavailable or too costly in terms of performance or memory usage, the Optimizing encoder identifies pixels and corresponding surface edges of each frame where aliasing is most perceptible. This usually corresponds to high-contrast boundaries on object silhouettes. The Optimizing encoder can then construct primitives to “smooth-over” the aliasing edges, such as line lists for polygonal models or curves for patches, and encode the data into the bit stream. In one preferred embodiment, the antialiasing primitives used are antialiased lines. For AA lines, the Optimizing Encoder performs the back to front sorting necessary to correctly apply the lines to the scene, in addition to identifying the subset of edges in the scene which most effectively improve image quality.

The fifteenth optimization is load-based scheduling of texture downloads by the Optimizing encoder. A common technique for enhancing the realism of interactive 3D graphics scenes is texture paging. Texture paging algorithms aim to make the most efficient use of texture memory by downloading texels to the graphics pipeline as they are needed for rendering each frame. Texels, which are anticipated to be needed must be downloaded to texture memory before surfaces to which they are applied are drawn. One such technique is Clip-Mapping, which is implemented with hardware support on SGI's InfiniteReality line of graphics engines. Clip-mapping provides support for paged textures with a toroidal topology to simulate texture maps of very large dimensions (e.g., 2 million by 2 million texels) using texture paging. Clip-Mapping is used effectively for textures applied to objects with a 2D topology and a predictable viewpoint, such as applying satellite photographs to a 3D terrain in a flight simulator. For more complex topologies or discontinuous viewpoint changes, it becomes more difficult to predict which texels will be needed in an interactive manner. Hardware-implemented page fault mechanisms such as AGP Texturing ameliorate this deficiency to a certain extent by providing a larger pool of available texture memory, but are not available on all platforms (particularly consumer-grade hardware such as the Sony Playstation 2), and incur a performance penalty for texels read from AGP memory. Another difficult aspect of texture paging is determining which texels need to be paged for reasons other than proximity. If in a flight simulator, for example, the viewer (pilot) may fly towards and over a mountain, a clip-map style texture pager would page all the texels for the mountain as the pilot approaches. If the pilot never dives down over the mountain such that the back side is visible, the texels for the back side of the mountain never contribute to the scene and therefore, were unnecessarily paged. Because the Optimizing encoder knows how much rendering time, texture memory bandwidth and player CPU time are required by the rendering processes for each frame interval on the Player, it can regulate the size and timing of texture downloads to the target platform's rendering hardware. It does this by encoding texture download commands directed to the foreground and background renderers within the bit stream. The Optimizing encoder can also schedule texture downloads by managing when the texels are placed in the bit stream. The Optimizing encoder also assures that textures are fully downloaded before they are needed for rendering. It can, if necessary, reduce scene complexity for frames prior to the texture deadline to make time for the necessary texture downloads.

The sixteenth optimization is explicit scheduling of microcode downloads by the Optimizing encoder. Most modem graphics systems use micro coded geometry processors, meaning the geometry unit of the graphics pipeline is programmable by means of microcode. For high-end systems, such as the SGI InfiniteReality, there is ample instruction memory attached to the geometry engine to store all of the microcode necessary to implement OpenGL. On lower end hardware, such as the Sony Playstation 2, there is much more limited microcode instruction memory. In order to implement a full-featured graphics API, sophisticated microcode paging schemes typically must be implemented, which can result in reloading of microcode memory many times during each frame. Schemes such as these require memory overhead to be implemented efficiently, and considerable geometry performance can be lost to microcode reloading penalties if the scene being drawn uses many different graphics features. Additionally, if such schemes are unable to perform adequate lookahead into the command stream, extra reloading exceptions can occur that might have been avoided if a larger block of the microcode were loaded at once. The optimizing encoder can also perform microcode optimization to improve the performance and reduce the instruction memory using well-known microcode optimization techniques or best-fit curve analysis. For example, if a shader performs the Frensel reflectivity computation, this may require 15 instructions per vertex to implement in real-time. If the fresnel coefficients are constant over the shaded model, however, the fresnel equation can be approximated with a simple exponential equation which may only require 10 instructions per vertex. The optimizing encoder keeps a palette of simplified curve types to use for each type of shading operation supported at a high-level and uses well-known curve fitting algorithms to determine the terms of the approximation curves best matching the shading equation given.

On target platforms where there is insufficient instruction memory to store the complete set of microcode for geometry processors, the Optimizing encoder keeps a table of which graphics state is required by the rendering operations within a frame to manage microcode downloads and improve rendering efficiency. In one embodiment, it does so through two primary techniques: ordering rendering commands to minimize graphics state changes to the current set of available microcode instructions; and, by inserting microcode download commands into the bit stream to explicitly specify which microcode instructions are necessary for subsequent rendering commands. The table of which micro instructions are used is populated by running a modified graphics driver on the target platform 22, which includes instructions in each command to report when each command is executed. This data is read back to host computer 21 for use as described above.

The seventeenth optimization is real time correction of physics modeling algorithms by the Optimizing encoder. A very effective way to add a great degree of realism to real time graphics is to model the interactions of modeled objects or particles with each other and their environment using physics modeling algorithms. Algorithms such as rigid body simulation are becoming commonplace in games. These algorithms can be computationally expensive, however, as inexpensive algorithms are often numerically unstable or insufficiently general to cover all the ways objects may interact or may not well approximate physical phenomena in all cases. Products such as those offered by MathEngine offer excellent, highly optimized real time rigid body simulations, for example, but they are not without computational cost, which computation may be better spent on other graphics tasks.

Because computationally inexpensive physics models for particle systems or other physically modeled phenomena can often be numerically unstable or inaccurate under certain circumstances, the Optimizing encoder can encode corrective data into the bit stream to improve the quality of the physics algorithms without slowing down their general case behavior. During the optimization unit, the Optimizing encoder executes both the numerically accurate and computationally efficient physics models, compares the results, and encodes corrective data into the bit stream when the discrepancies between the two models exceed a specific tolerance. Another way the Optimizing encoder can dramatically improve the efficiency of real time physics algorithms in complex environments is to construct subsets of the set of objects which may interact with each other over specified time intervals, which can reduce the computational burden of testing for the interaction of each object with every other object in real time.

The eighteenth optimization is pre-computed state and mode sorting. In real time graphics systems, there are two main operations the system can perform: issuing of drawing commands, and the selection of the different drawing mode and parameters used in the drawing. Since these parameter changes are usually expensive, a technique called more sorting is generally used, where the application tries to re-order the scene to combine everything that is drawn with a given mode or material in order to minimize these mode change commands.

For example, it is very common to sort the scene according to which texture objects use, so that unnecessary texture commands can be avoided by drawing everything that uses a given texture together.

This sorting usually must happen in real time, since the actual viewpoint and scene content is not known a priori, and can turn out to be an expensive process that consumes a significant portion of the frame time. By using all the existing scene information, the Optimizing compiler can pre-compute optimal sorted scenes, looking not only at the current frame but also at future mode changes that have not yet taken place in the scene but will in a few frames, and that can affect the result of the optimal sorting process.

Another possible state sorting optimization for the Optimizing compiler is state reduction, where mode changes that have actual parameters such as colors, light intensities or transparency values can be tracked and compared against a threshold value. Only mode changes that exceed the threshold for each given scene need to be issued to the graphics processor.

This particular optimization is especially useful if performed at the very end, since many of the other optimizations can introduce or modify the state of the rendered scene.

Various embodiments of the present invention have been described above. Many aspects of the invention are independent of scene complexity and bandwidth, and are capable of being implemented on a variety of computer systems capable of interactive 3D graphics. It should be understood that these embodiments have been presented by way of example only, and not limitation. It will be understood by those skilled in the relevant art that various changes in form and the details of the embodiments described above may be made without departing from the spirit and scope of the present invention.

What is claimed is:

1. A system for optimizing non-interactive three-dimensional image data comprising:
an optimizing encoder for generating three-dimensional rendering information optimized for real-time rendering of an image having an image quality within an error criteria of an image quality standard for a target computer system, and the optimizing encoder further having a model representing the target computer system for performing rendering of the rendering information, the target computer system represented being a type of computer system having a three-dimensional renderer.

2. The system of claim 1 wherein the optimizing encoder performs an optimization of the three-dimensional rendering information based upon criteria including a graphics processor capability of the target computer system.

3. The system of claim 2 wherein the optimizing encoder performs an optimization of the three-dimensional rendering information based upon criteria including characteristics of a physical infrastructure for transferring the optimized three-dimensional rendering information to the target computer system.

4. The system of claim 3 wherein the physical infrastructure is the Internet.

5. The system of claim 3 wherein the physical infrastructure is a digital versatile disc.

6. The system of claim 3 wherein the computer system is an interactive game console.

7. The system of claim 2 wherein the optimizing encoder performs an optimization of the three-dimensional rendering information based upon criteria including feedback information generated by the model during rendering of the three-dimensional rendering information.

8. The system of claim 7 wherein the feedback information includes a rendering time measurement for a subset of a scene.

9. The system of claim 7 wherein the feedback information includes a rendering time measurement for a scene.

10. The system of claim 7 wherein the optimizing encoder has a memory and the feedback information includes rendered pixels generated by the model in rendering the optimized three-dimensional rendering information.

11. The system of claim 7 wherein the feedback information includes command error reporting.

12. The system of claim 7 wherein the optimizing encoder has a processor and a memory and the model is a software emulation of the target computer system executing on the processor for rendering three-dimensional rendering information.

13. The system of claim 7 wherein the model comprises a graphics processor for rendering the optimized three-dimensional image data.

14. The system of claim 7 wherein the model is a graphics sub-system embodied in a peripheral of the optimizing encoder.

15. The system of claim 1 wherein the optimizing encoder comprises:
an import unit for converting three-dimensional descriptions to an intermediate format suitable for a plurality of target computer systems;
a multi-platform unit for generating a first optimized three-dimensional data set by performing computations applicable to a plurality of target computer systems;
a target-specific optimization unit for generating a second optimized three-dimensional data set for a selected one of the target computer systems by performing at least one optimization applicable to the selected target system; and
a bandwidth tuning unit for encoding the second optimized three-dimensional data set in a three-dimensional protocol accounting for the characteristics of a physical infrastructure from which the selected target computer system will access the second data set.

16. A method for optimizing non-interactive three-dimensional image data for rendering by a target computer system comprising:
generating three-dimensional rendering information optimized for real-time rendering of an image having an image quality within an error criteria of an image quality standard for the target computer system, the target computer system represented being a type of computer system having a three-dimensional renderer; and
encoding the optimized three-dimensional image data into a three-dimensional protocol.

17. The method of claim 16 wherein the three-dimensional protocol is a streaming protocol.

18. The method of claim 16 wherein generating three-dimensional rendering information optimized for real-time rendering of an image having an image quality within an error criteria of an image quality standard for the target computer system comprises:
performing an optimization based upon the graphics processor capability of the target computer system.

19. The method of claim 16 wherein generating three-dimensional rendering information optimized for real-time rendering of an image having an image quality within an error criteria of an image quality standard for the target computer system comprises:
receiving feedback information from a rendering of the image by a model of the target system; and
selecting an optimization to be performed based on the feedback information.

20. The method of claim 16 wherein the encoding of the optimized three-dimensional image data into a three-dimensional protocol comprises:
encoding the rendering information to satisfy the bandwidth requirement of a physical infrastructure used for transferring the optimized information to the target computer system.

21. The method of claim 16 wherein generating three-dimensional rendering information optimized for real-time rendering of an image having an image quality within an error criteria of an image quality standard for the target computer system comprises the following:
converting three-dimensional descriptions to an intermediate format suitable for a plurality of target computer systems;
generating a first optimized three-dimensional data set by performing computations applicable to a plurality of target computer systems;
generating a second optimized three-dimensional data set for a selected one of the target computer systems by performing at least one optimization applicable to the selected target system; and
encoding the second optimized three-dimensional data set in a three-dimensional protocol accounting for the characteristics of a physical infrastructure from which the selected target computer system will access the second data set.

22. The method of claim 21 wherein the at least one optimization is an optimization based on microcode generation.

23. The method of claim 21 wherein the at least one optimization is an optimization involving injecting corrective data.

24. The method of claim 21 wherein the at least one optimization is an optimization based on scheduling of object rendering and reordering of objects to be rendered.

25. The method of claim 21 wherein the at least one optimization is an image based rendering technique.

26. The method of claim 21 wherein the at least one optimization is an optimization involving deletion of unused data or delaying of rendering of data.

27. The method of claim 21 wherein the at least one optimization is an optimization involving pre-computing runtime parameters.

28. The method of claim 21 wherein the at least one optimization is an optimization involving optimizing assets.

29. The method of claim 21 wherein the at least one optimization is an optimization involving texture creation.

30. The method of claim 21 wherein the at least one optimization is an optimization involving shading computations.

31. The method of claim 21 wherein the at least one optimization is an optimization involving manipulating geometry of objects within the image.

32. The method of claim 21 wherein the at least one optimization is an optimization involving visibility determination of objects within the image.

33. The method of claim 21 wherein the at least one optimization is an optimization involving compression.

34. A system for optimizing non-interactive three-dimensional image data for rendering by a target computer system comprising:
means for generating three-dimensional rendering information optimized for real-time rendering of an image having an image quality within an error criteria of an image quality standard for the target computer system, the target computer system represented being a type of computer system having a three-dimensional renderer; and
means for encoding the optimized three-dimensional image data into a three-dimensional protocol.

35. A computer usable medium comprising instructions that when executed by a processor perform the following method for optimizing non-interactive three-dimensional image data for rendering by a target computer system comprising:
generating three-dimensional rendering information optimized for real-time rendering of an image having an image quality within an error criteria of an image quality standard for the target computer system, the target computer system represented being a type of computer system having a three-dimensional renderer; and
encoding the optimized three-dimensional image data into a three-dimensional protocol.
